(19) United States
(12) Patent Application Publication
(10) Pub. No.: US 2011/0261037 A1
(43) Pub. Date: Oct. 27, 2011

(54) ACTIVE MATRIX PIXELS WITH INTEGRAL PROCESSOR AND MEMORY UNITS

(75) Inventors: Alok Govil, Santa Clara, CA (US); Tsongming Kao, Sunnyvale, CA (US); Marc M. Mignard, San Jose, CA (US); SuryaPrakash Ganti, Los Altos, CA (US); Philip D. Floyd, Redwood City, CA (US); Manish Kothari, Cupertino, CA (US)

(73) Assignee: QUALCOMM MEMS Technologies, Inc., San Diego, CA (US)

(21) Appl. No.: 13/092,087

(22) Filed: Apr. 21, 2011

Related U.S. Application Data
(60) Provisional application No. 61/327,014, filed on Apr. 22, 2010.

(51) Int. Cl. G06F 3/038

(52) U.S. Cl. 345/205

(57) ABSTRACT

This disclosure provides methods, systems and apparatus for storing and processing image data at the pixel using augmented active matrix pixels. Some implementations of a display device may include a substrate, an array of display elements associated with the substrate and configured to display an image, an array of processor units associated with the substrate, wherein each processor unit is configured to process image data for a respective portion of the display elements and an array of memory units associated with the array of processor units, wherein each memory unit is configured to store data for a respective portion of the display elements. Some implementations may enable color processing image data at the pixel, layering of image data at the pixel or temporal modulation of image data at the pixel. Further, in some implementations, the display element may be an interferometric modulator (IMOD). Some other implementations may additionally include a display, a processor configured to communicate with the display and a memory device that is configured to communicate with the processor.

### CROSS-REFERENCE TO RELATED APPLICATIONS

This disclosure claims priority to U.S. Provisional Patent Application No. 61/327,014, filed Apr. 22, 2010, entitled “ACTIVE MATRIX PIXELS WITH INTEGRAL PROCESSOR AND MEMORY UNITS,” and assigned to the assignee hereof. The disclosure of the prior application is considered part of, and is incorporated by reference in, this disclosure.

### TECHNICAL FIELD

This disclosure relates to display devices. More particularly, this disclosure relates to processing image data in a processing and memory unit located near the display pixels.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display device including at least one substrate; an array of display elements associated with the at least one substrate and configured to display an image; an array of processor units associated with the at least one substrate, wherein each processor unit is configured to process image data for a respective portion of the display elements; and an array of memory units associated with the array of processor units, wherein each memory unit is configured to store data for a respective portion of the display elements. In some implementations, the display elements can be interferometric modulators. In other implementations, each of the processing units can be configured to process image data provided to its respective portion of the display elements for processing a color to be displayed by the portion of the display elements. In further implementations, each of the processing units can be configured to process image data provided to its respective portion of the display elements for layering an image to be displayed by the array of display element. In some implementations, each of the processing units can be configured to process image data provided to its respective portions of the display elements for temporally modulating an image to be displayed by the array of display elements. In some implementations, each of the processing units is configured to process image data provided to its respective portion of the display elements for double-buffering an image to be displayed by the array of display elements. Other implementations may additionally include a display; a processor that is configured to communicate with the display, the processor being configured to process image data; and a memory device that is configured to communicate with the processor.

Another innovative aspect of the subject matter described in this disclosure can be implemented in a display device including means for receiving image data at a pixel; means for storing the image data at the pixel; and means for processing the image data at the pixel. Other implementations may additionally include one or more display elements located at the pixel. In some implementations, the one or more display elements can be interferometric modulators.

Another innovative aspect of the subject matter described in this disclosure can be implemented in a method of processing an image for a display device including an array of pixels, the method including receiving image data at a pixel; storing the image data in a memory unit located at the pixel; and processing the image data with a processing unit located at the pixel. Some implementations may additionally include receiving color processing data at the pixel; processing the stored image data according to the color processing data; and displaying the processed image data at the pixel. Other implementations may additionally include receiving layer image data at the pixel; storing layer image data in a memory unit located at the pixel; receiving layer selection data at the pixel; and displaying at least one of the image data or the layer image data at the pixel according to the layer selection data. Further implementations may additionally include receiving image data having a color depth at the pixel and temporally modulating the display elements of the pixel to reproduce the color depth at the pixel. Additional implementations may additionally include receiving image data at all the pixels of the display and simultaneously writing the image data to substantially all the pixels of the display.

Another innovative aspect of the subject matter described in this disclosure can be implemented in a method of displaying image data at a display device, including an array of pixels, the method including storing data for a plurality of images in a memory device located at a pixel; selecting image data from one of the plurality of images; and displaying the selected image data at the pixel. Some implementations may include storing alpha channel data in a memory device located at the pixel. In some implementations, the selection of image data can be based at least in part on the alpha channel data.

Another innovative aspect of the subject matter described in this disclosure can be implemented in a method of displaying image data at a display device including an array of pixels, the method including storing first image data for all the pixels of the array in memory devices located at each pixel and simultaneously transferring the first image data for all the pixels of the array to display elements located at each pixel for display. Some implementations may additionally include storing second image data for all the pixels in the array in memory devices located at each pixel while the first image data is being displayed. Other implementations may also include simultaneously transferring the second image data for all the pixels of the array to display elements located at each pixel for display and storing third image data for all the pixels in the array in memory devices located at each pixel while the second image data is being displayed.

Details of one or more implementations of the subject matter described in this specification are set forth in the accompanying drawings and the description below. Other features, aspects, and advantages will become apparent from the description, the drawings, and the claims. While the configurations of the devices and methods described herein are described with respect to optical MEMS devices, a person having ordinary skill in the art will readily recognize that similar devices and methods may be used with other appropriate display technologies. Note that the relative dimensions of the following figures may not be drawn to scale.

### BRIEF DESCRIPTION OF THE DRAWINGS

FIGS. 1A and 1B show examples of isometric views depicting a pixel of an interferometric modulator (IMOD) display device in two different states.

FIG. 2 shows an example of a schematic circuit diagram illustrating a driving circuit array for an optical MEMS display device.

FIG. 3 shows an example of a schematic partial cross-section illustrating one implementation of the structure of the driving circuit and the associated display element of FIG. 2.

FIG. 4 shows an example of a schematic exploded partial perspective view of an optical MEMS display device having an interferometric modulator array and a backplate.

FIG. 5A shows an example of a schematic circuit diagram of a driving circuit array for an optical MEMS display.

FIG. 5B shows an example of a schematic cross-section of a processing unit and an associated display element of the optical MEMS display of FIG. 6.

FIG. 6 shows an example of a schematic block diagram of an array of image data processing units for an optical MEMS display.

FIG. 7 shows an example of a schematic block diagram of an array of image data processing units for an optical MEMS display.

FIG. 8 shows an example of a schematic partial perspective view of an array of image data processing units for an optical MEMS display.

FIG. 9 shows an example of a schematic block diagram of an augmented active matrix pixel with an integral processor unit configured to process color data.

FIGS. 10A and 10B show examples of schematic block diagrams of augmented active matrix pixels with integral processor units and memory units configured to implement alpha compositing.

FIG. 11 shows an example of a schematic block diagram of an augmented active matrix pixel with integral processor unit and memory units configured to implement temporal modulation.

FIGS. 12A and 12B show examples of displays configured to buffer image data.

FIG. 13 shows an example of a method of storing and processing image data with an augmented active matrix pixel.

FIG. 14 shows an example of a method of temporally modulating image data with an augmented active matrix pixel.

FIG. 15 shows an example of a method of implementing advanced buffering techniques with an augmented active matrix pixel.

FIGS. 16A and 16B show examples of system block diagrams illustrating a display device that includes a plurality of interferometric modulators.

FIG. 17 shows an example of a schematic exploded perspective view of an electronic device having an optical MEMS display.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

One of the most prominent causes of power dissipation within an information display module is power consumed in writing content onto the display. Power dissipation during content writing is primarily due to the power needed to send the content from outside the display to the respective pixels of the display element. For passive-matrix displays, this involves using several data lines bearing high capacitance connecting to several pixels each. Each time any pixel on a given data line is written, the capacitance of the whole data line, which is connected to a multitude of pixels, needs to be driven. This results in high power dissipation. Active matrix displays use switches to isolate capacitance of pixels from the data line. Thus, active matrix displays significantly reduce the net capacitance of the data line compared to passive matrix designs. Even though active matrix designs reduce data line capacitance, writing data to the pixels in an active matrix display still causes power dissipation. Devices and methods are described herein that relate to display apparatus that contain processor and memory circuitry near the display elements. Implementations may include methods of augmenting active matrix display pixels to perform processing and storage at the pixel, as well as systems and devices utilizing the augmented pixels. The processing and memory circuitry can be used for a variety of functions, including temporal modulation, color processing, image layering, and image data buffering.

Particular implementations of the subject matter described in this disclosure can be implemented to realize one or more of the following potential advantages. Augmented active matrix pixels can be implemented to have more capability while still requiring less power to accomplish enhanced functionality. For example, processing of image data at the pixel may be accomplished without the need to process data outside of the display and then write it back to the display. This can reduce the load on off-display processors as well as reducing the overall power consumption because the processed image data need not be written back to the display after processing. Examples of processing that may be offloaded to the pixel include: color processing; alpha compositing, which allows images to be overlaid and rendered transparent; layering of image data, which can be selectively activated and deactivated without writing any additional image data to the display; and advanced buffering techniques such as multiple-buffering.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

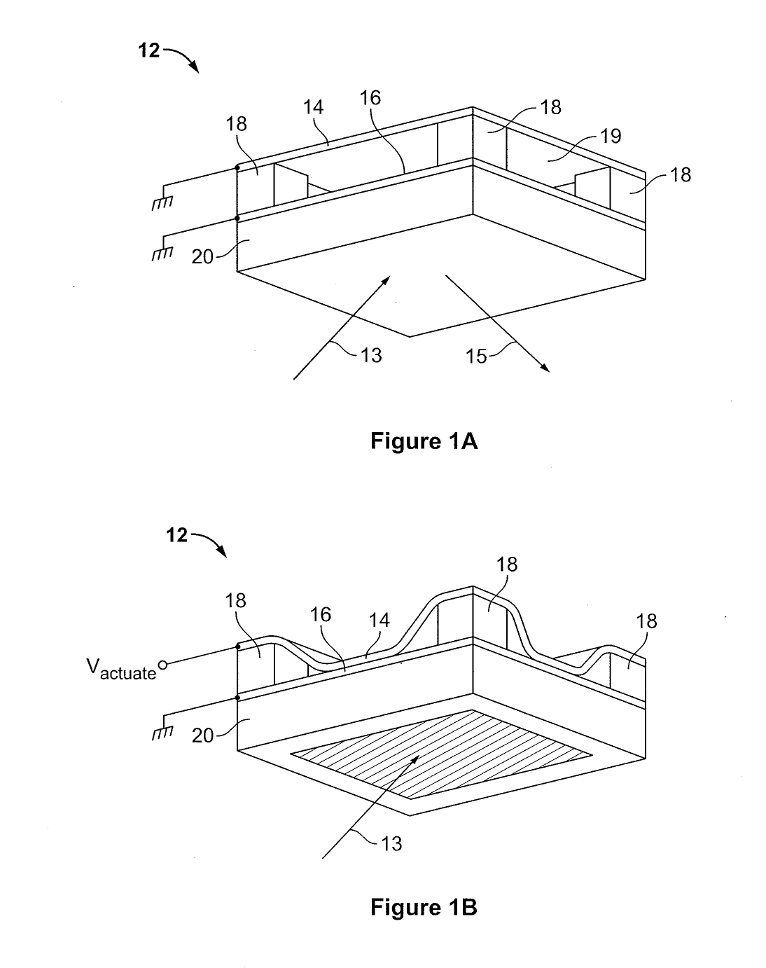

FIGS. 1A and 1B show examples of isometric views depicting a pixel of an interferometric modulator (IMOD) display device in two different states. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted pixels in FIGS. 1A and 1B depict two different states of an IMOD 12. In the IMOD 12 in FIG. 1A, a movable reflective layer 14 is illustrated in a relaxed position at a predetermined (e.g., designed) distance from an optical stack 16, which includes a partially reflective layer. Since no voltage is applied across the IMOD 12 in FIG. 1A, the movable reflective layer 14 remained in a relaxed or unactuated state. In the IMOD 12 in FIG. 1B, the movable reflective layer 14 is illustrated in an actuated position and adjacent, or nearly adjacent, to the optical stack 16. The voltage V_{actuate} applied across the IMOD 12 in FIG. 1B is sufficient to actuate the movable reflective layer 14 to an actuated position.

In FIGS. 1A and 1B, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixels 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the optical stack 16, or lower electrode, is grounded at each pixel. In some implementations, this may be accomplished by depositing a continuous optical stack 16 onto the substrate 20 and grounding at least a portion of the continuous optical stack 16 at the periphery of the deposited layers. In some implementations, a highly conductive and reflective material, such as aluminum (Al), may be used for the movable reflective layer 14. The movable reflective layer 14 may be formed as a metal layer or layers deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 in FIG. 1A, with the gap 19 between the movable reflective layer 14 and optical stack 16. However, when a potential difference, e.g., voltage, is applied to at least one of the movable reflective layer 14 and optical stack 16, the capacitor formed at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 in FIG. 1B. The behavior is the same regardless of the polarity of the applied potential difference. Though a series of pixels in an array may be referred to in some implementations as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, such as in a series or array of IMODs, the optical stacks 16 can serve as a common electrode that provides a common voltage to one side of the IMODs 12. The movable reflective layers 14 may be formed as an array of separate plates arranged in, for example, a matrix form. The separate plates can be supplied with voltage signals for driving the IMODs 12.

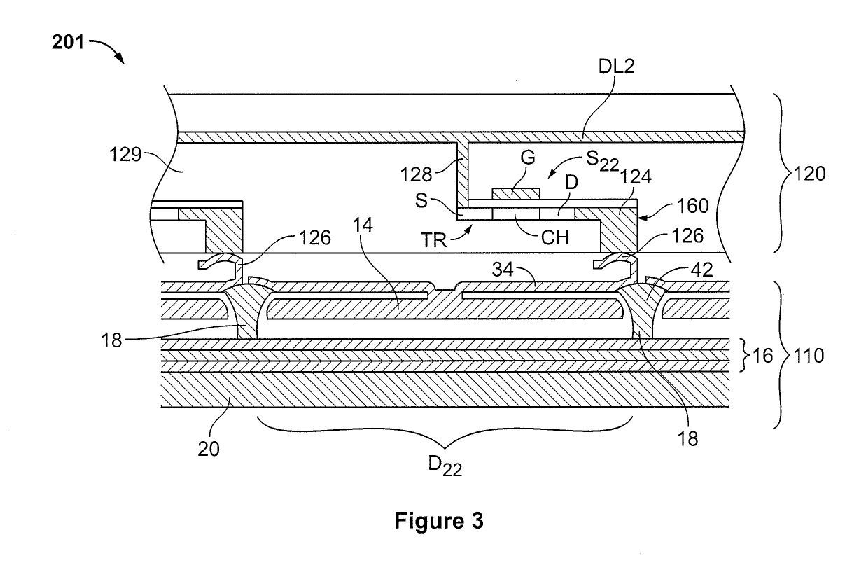

The details of the structure of interferometric modulators that operate in accordance with the principles set forth above may vary widely. For example, the movable reflective layers 14 of each IMOD 12 may be attached to supports at the corners only, e.g., on tethers. As shown in FIG. 3, a flat, relatively rigid movable reflective layer 14 may be suspended from a deformable layer 34, which may be formed from a flexible metal. This architecture allows the structural design and materials used for the electromechanical aspects and the optical aspects of the modulator to be selected, and to function, independently of each other. Thus, the structural design and materials used for the movable reflective layer 14 can be optimized with respect to the optical properties, and the structural design and materials used for the deformable layer 34 can be optimized with respect to desired mechanical properties. For example, the movable reflective layer 14 portion may be aluminum, and the deformable layer 34 portion may be nickel. The deformable layer 34 may connect, directly or indirectly, to the substrate 20 around the perimeter of the deformable layer 34. These connections may form the support posts 18.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing.

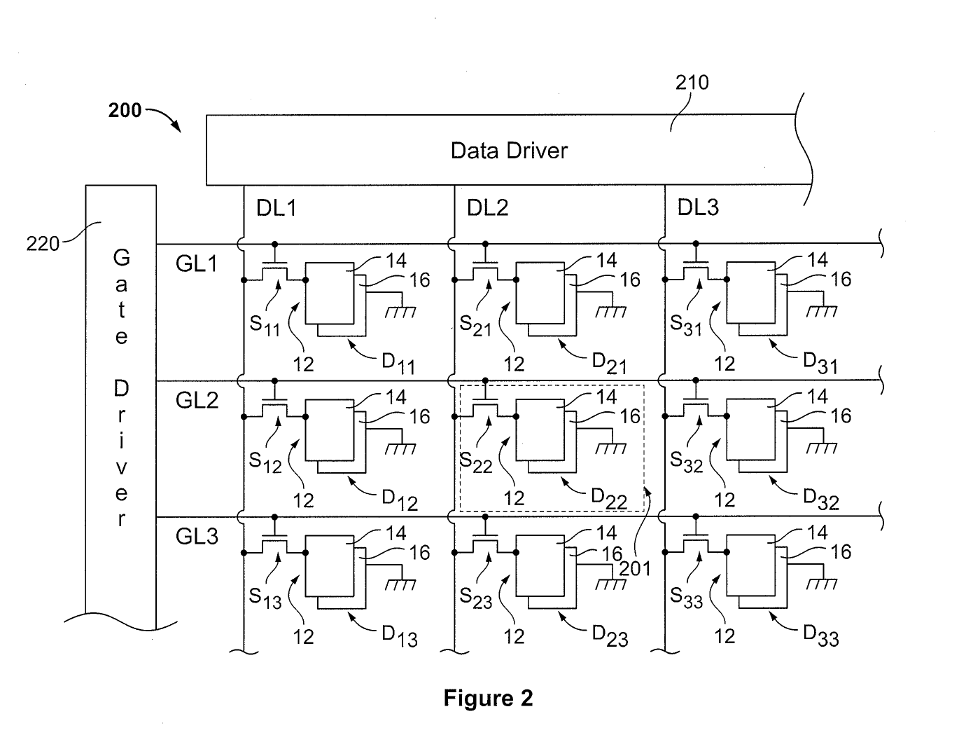

FIG. 2 shows an example of a schematic circuit diagram illustrating a driving circuit array for an optical MEMS display device. The driving circuit array 200 can be used for implementing an active matrix addressing scheme for providing image data to display elements D₁₁-Dₘₙ of a display array assembly.

The driving circuit array 200 includes a data driver 210, a gate driver 220, first to m-th data lines DL1-DLm, first to n-th gate lines GL1-GLn, and an array of switches or switching circuits S₁₁-Sₘₙ. Each of the data lines DL1-DLm extends from the data driver 210, and is electrically connected to a respective column of switches S₁₁-S₁ₙ, S₂₁-S₂ₙ, . . . , Sₘ₁-Sₘₙ. Each of the gate lines GL1-GLn extends from the gate driver 220, and is electrically connected to a respective row of switches S₁₁-Sₘ₁, S₁₂-Sₘ₂, . . . , S₁ₙ-Sₘₙ. The switches S₁₁-Sₘₙ are electrically coupled between one of the data lines DL1-DLm and a respective one of the display elements D₁₁-Dₘₙ and receive a switching control signal from the gate driver 220 via one of the gate lines GL1-GLn. The switches S₁₁-Sₘₙ are illustrated as single FET transistors, but may take a variety of forms such as two transistor transmission gates (for current flow in both directions) or even mechanical MEMS switches.

The data driver 210 can receive image data from outside the display, and can provide the image data on a row by row basis in a form of voltage signals to the switches S₁₁-Sₘₙ via the data lines DL1-DLm. The gate driver 220 can select a particular row of display elements D₁₁-Dₘ₁, D₁₂-Dₘ₂, . . . , D₁ₙ-Dₘₙ by turning on the switches S₁₁-Sₘ₁, S₁₂-Sₘ₂, . . . , S₁ₙ-Sₘₙ associated with the selected row of display elements D₁₁-Dₘ₁, D₁₂-Dₘ₂, . . . , D₁ₙ-Dₘₙ. When the switches S₁₁-Sₘ₁, S₁₂-Sₘ₂, . . . , S₁ₙSₘₙ in the selected row are turned on, the image data from the data driver 210 is passed to the selected row of display elements D₁₁-Dₘ₁, D₁₂-Dₘ₂, . . . , D₁ₙ-Dₘₙ.

During operation, the gate driver 220 can provide a voltage signal via one of the gate lines GL1-GLn to the gates of the switches S₁₁-Sₘₙ in a selected row, thereby turning on the switches S₁₁-Sₘₙ. After the data driver 210 provides image data to all of the data lines DL1-DLm, the switches S₁₁-Sₘₙ of the selected row can be turned on to provide the image data to the selected row of display elements D₁₁-Dₘ₁, D₁₂-Dₘ₂, . . . , D₁ₙ-Dₘₙ, thereby displaying a portion of an image. For example, data lines DL that are associated with pixels that are to be actuated in the row can be set to, e.g., 10-volts (could be positive or negative), and data lines DL that are associated with pixels that are to be released in the row can be set to, e.g., 0-volts. Then, the gate line GL for the given row is asserted, turning the switches in that row on, and applying the selected data line voltage to each pixel of that row. This charges and actuates the pixels that have 10-volts applied, and discharges and releases the pixels that have O-volts applied. Then, the switches S₁₁-Sₘₙ can be turned off. The display elements D₁₁-Dₘ₁, D₁₂-Dₘ₂, . . . , D₁ₙ-Dₘₙ can hold the image data because the charge on the actuated pixels will be retained when the switches are off, except for some leakage through insulators and the off state switch. Generally, this leakage is low enough to retain the image data on the pixels until another set of data is written to the row. These steps can be repeated to each succeeding row until all of the rows have been selected and image data has been provided thereto. In the implementation of FIG. 2, the optical stack 16 is grounded at each pixel. In some implementations, this may be accomplished by depositing a continuous optical stack 16 onto the substrate and grounding the entire sheet at the periphery of the deposited layers.

FIG. 3 shows an example of a schematic partial cross-section illustrating one implementation of the structure of the driving circuit and the associated display element of FIG. 2. A portion 201 of the driving circuit array 200 includes the switch S₂₂ at the second column and the second row, and the associated display element D₂₂. In the illustrated implementation, the switch S₂₂ includes a transistor 80. Other switches in the driving circuit array 200 can have the same configuration as the switch S₂₂, or can be configured differently, for example by changing the structure, the polarity, or the material.

FIG. 3 also includes a portion of a display array assembly 110, and a portion of a backplate 120. The portion of the display array assembly 110 includes the display element D₂₂ of FIG. 2. The display element D₂₂ includes a portion of a front substrate 20, a portion of an optical stack 16 formed on the front substrate 20, supports 18 formed on the optical stack 16, a movable reflective layer 14 (or a movable electrode connected to a deformable layer 34) supported by the supports 18, and an interconnect 126 electrically connecting the movable reflective layer 14 to one or more components of the backplate 120.

The portion of the backplate 120 includes the second data line DL2 and the switch S₂₂ of FIG. 2, which are embedded in the backplate 120. The portion of the backplate 120 also includes a first interconnect 128 and a second interconnect 124 at least partially embedded therein. The second data line DL2 extends substantially horizontally through the backplate 120. The switch S₂₂ includes a transistor 80 that has a source 82, a drain 84, a channel 86 between the source 82 and the drain 84, and a gate 88 overlying the channel 86. The transistor 80 can be, e.g., a thin film transistor (TFT) or metal-oxide-semiconductor field effect transistor (MOSFET). The gate of the transistor 80 can be formed by gate line GL2 extending through the backplate 120 perpendicular to data line DL2. The first interconnect 128 electrically couples the second data line DL2 to the source 82 of the transistor 80.

The transistor 80 is coupled to the display element D₂₂ through one or more vias 160 through the backplate 120. The vias 160 are filled with conductive material to provide electrical connection between components (for example, the display element D₂₂) of the display array assembly 110 and components of the backplate 120. In the illustrated implementation, the second interconnect 124 is formed through the via 160, and electrically couples the drain 84 of the transistor 80 to the display array assembly 110. The backplate 120 also can include one or more insulating layers 129 that electrically insulate the foregoing components of the driving circuit array 200.

The optical stack 16 of FIG. 3 is illustrated as three layers, a top dielectric layer described above, a middle partially reflective layer (such as chromium) also described above, and a lower layer including a transparent conductor (such as indium-tin-oxide (ITO)). The common electrode is formed by the ITO layer and can be coupled to ground at the periphery of the display. In some implementations, the optical stack 16 can include more or fewer layers. For example, in some implementations, the optical stack 16 can include one or more insulating or dielectric layers covering one or more conductive layers or a combined conductive/absorptive layer.

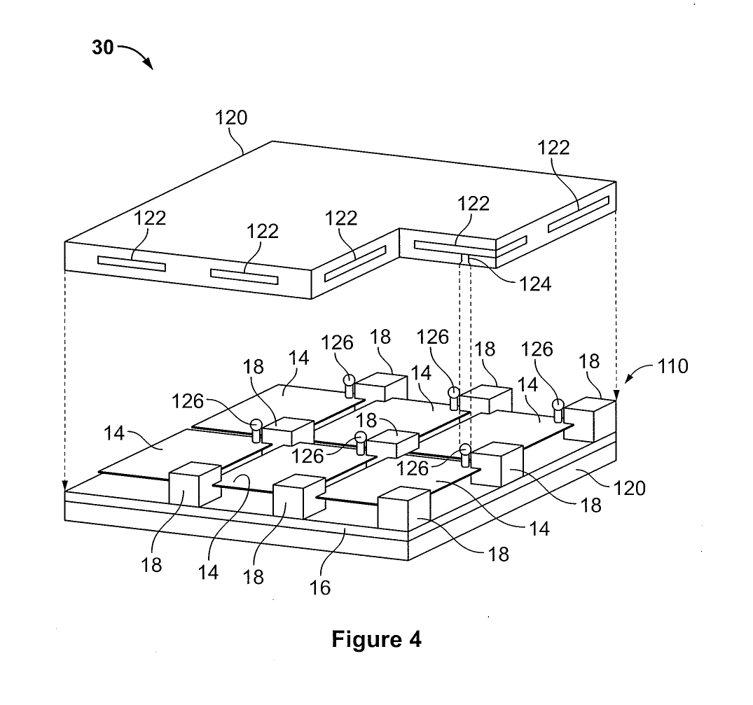

FIG. 4 shows an example of a schematic exploded partial perspective view of an optical MEMS display device having an interferometric modulator array and a backplate. The display device 30 includes a display array assembly 110 and a backplate 120. In some implementations, the display array assembly 110 and the backplate 120 can be separately pre-formed before being attached together. In some other implementations, the display device 30 can be fabricated in any suitable manner, such as, by forming components of the backplate 120 over the display array assembly 110 by deposition.

The display array assembly 110 can include a front substrate 20, an optical stack 16, supports 18, a movable reflective layer 14, and interconnects 126. The backplate 120 can include backplate components 122 at least partially embedded therein, and one or more backplate interconnects 124.

The optical stack 16 of the display array assembly 110 can be a substantially continuous layer covering at least the array region of the front substrate 20. The optical stack 16 can include a substantially transparent conductive layer that is electrically connected to ground. The reflective layers 14 can be separate from one another and can have, e.g., a square or rectangular shape. The movable reflective layers 14 can be arranged in a matrix form such that each of the movable reflective layers 14 can form part of a display element. In the implementation illustrated in FIG. 4, the movable reflective layers 14 are supported by the supports 18 at four corners.

Each of the interconnects 126 of the display array assembly 110 serves to electrically couple a respective one of the movable reflective layers 14 to one or more backplate components 122 (e.g., transistors S and/or other circuit elements). In the illustrated implementation, the interconnects 126 of the display array assembly 110 extend from the movable reflective layers 14, and are positioned to contact the backplate interconnects 124. In another implementation, the interconnects 126 of the display array assembly 110 can be at least partially embedded in the supports 18 while being exposed through top surfaces of the supports 18. In such an implementation, the backplate interconnects 124 can be positioned to contact exposed portions of the interconnects 126 of the display array assembly 110. In yet another implementation, the backplate interconnects 124 can extend from the backplate 120 toward the movable reflective layers 14 so as to contact and thereby electrically connect to the movable reflective layers 14.

The interferometric modulators described above have been described as bi-stable elements having a relaxed state and an actuated state. The above and following description, however, also may be used with analog interferometric modulators having a range of states. For example, an analog interferometric modulator can have a red state, a green state, a blue state, a black state and a white state, in addition to other color states. Accordingly, a single interferometric modulator can be configured to have various states with different light reflectance properties over a wide range of the optical spectrum.

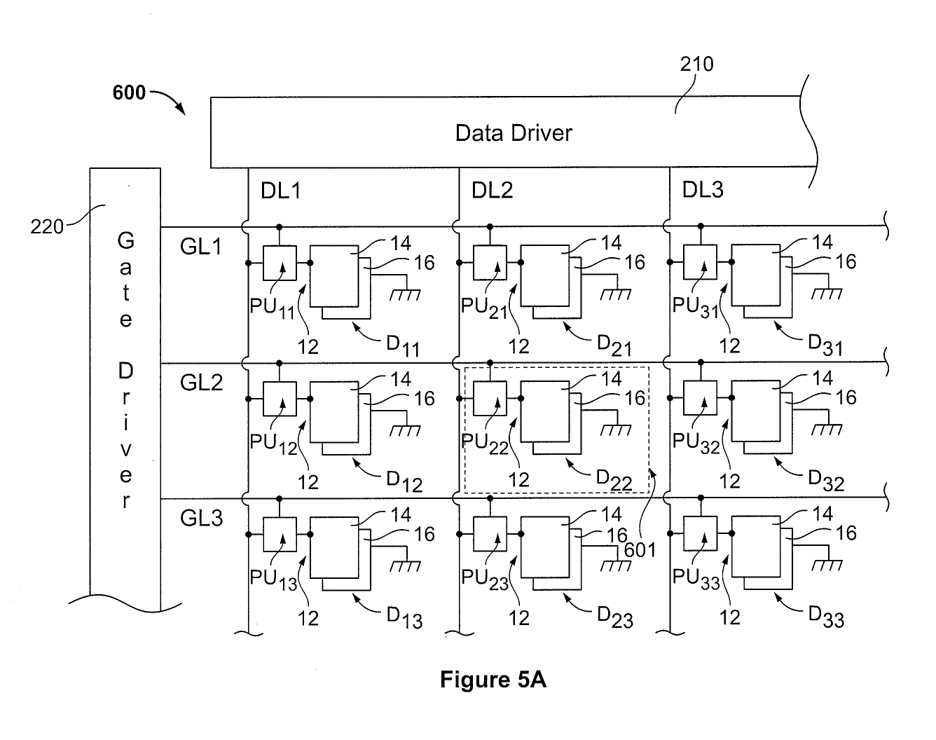

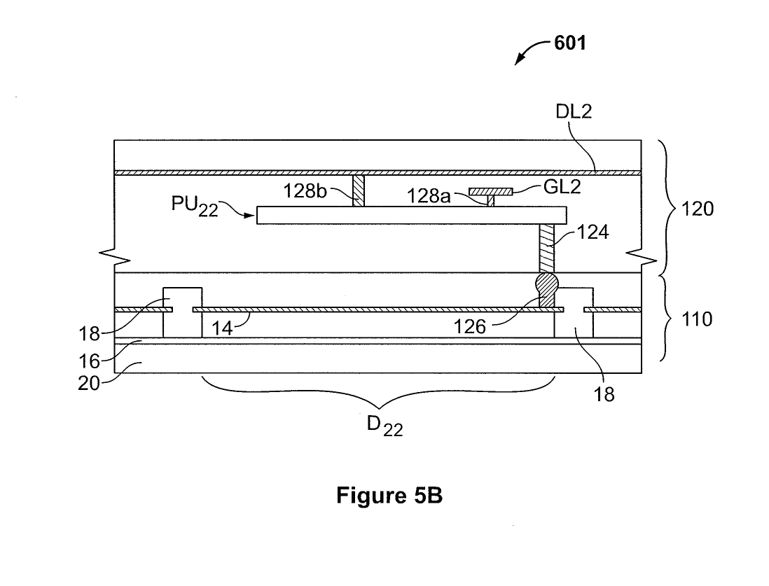

FIG. 5A shows an example of a schematic circuit diagram of a driving circuit array for an optical MEMS display. Referring now to this FIG. 5A, a driving circuit array of a display device according to some implementations will be described below. The illustrated driving circuit array 600 can be used for implementing an active matrix addressing scheme for providing image data to display elements D₁₁-Dₘₙ of a display array assembly. Each of the display elements D₁₁-Dₘₙ can include a pixel 12 which includes a movable electrode 14 and an optical stack 16.

The driving circuit array 600 includes a data driver 210, a gate driver 220, first to m-th data lines DL1-DLm, first to n-th gate lines GL1-GLn, an array of processing units PU₁₁-PUₘₙ. Each of the data lines DL1-DLm extends from the data driver 210, and is electrically connected to a respective column of processing units PU₁₁-PU₁ₙ, PU₂₁-PU₂ₙ, . . . , PUₘ₁-PUₘₙ. Each of the gate lines GL1-GLn extends from the gate driver 220, and is electrically connected to a respective row of processing units PU₁₁-PUₘ₁, PU₁₂-PUₘ₂, . . . , PU₁ₙ-PUₘₙ.

The data driver 210 serves to receive image data from outside the display, and provide the image data in a form of voltage signals to the processing units PU₁₁-PUₘₙ via the data lines DL1-DLm for processing the image data. The gate driver 220 serves to select a row of display elements D₁₁-Dₘ₁, D₁₂-Dₘ₂, . . . , D₁ₙ-Dₘₙ by providing switching control signals to the processing units PU₁₁-PUₘ₁, PU₁₂-PUₘ₂, . . . , PU₁ₙ-PUₘₙ associated with the selected row of display elements D₁₁-Dₘ₁, D₁₂-Dₘ₂, . . . , D₁ₙ-Dₘₙ.

Each of the processing units PU₁₁-PUₘₙ is electrically coupled to a respective one of the display elements D₁₁-Dₘₙ while being configured to receive a switching control signal from the gate driver 220 via one of the gate lines GL1-GLn. The processing units PU₁₁-PUₘₙ can include one or more switches that are controlled by the switching control signals from the gate driver 220 such that image data processed by the processing units PU₁₁-PUₘₙ are provided to the display elements D₁₁-Dₘₙ. In another implementation, the driving circuit array 600 can include an array of switching circuits, and each of the processing units PU₁₁-PUₘₙ can be electrically connected to one or more, but less than all, of the switches.

In some implementations, the processed image data can be provided to rows of display elements D₁₁-Dₘ₁, D₁₂-Dₘ₂, . . . , D₁ₙ-Dₘₙ from the corresponding rows of processing units PU₁₁-PUₘ₁, PU₁₂-PUₘ₂, PU₁₃-PUₘ₃, . . . , PU₁ₙ-PUₘₙ. In some implementations, each of the processing units PU₁₁-PUₘₙ can be integrated with a respective one of the pixels 12.

During operation, the data driver 210 provides single or multi-bit image data, via the data lines DL1-DLm, to rows of processing units PU₁₁-PUₘ₁, PU₁₂-PUₘ₂, . . . , PU₁ₙ-PUₘₙ, row by row. The processing units PU₁₁-PUₘₙ then together process the image data to be displayed by the display elements D₁₁-Dₘₙ.

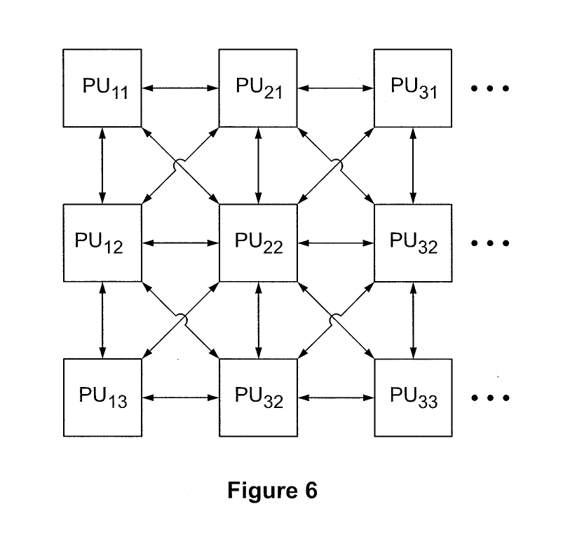

FIG. 5B shows an example of a schematic cross-section of a processing unit and an associated display element of the optical MEMS display of FIG. 6. The illustrated portion includes the portion 601 of the driving circuit array 600 in FIG. 5A. The illustrated portion includes a portion of a display array assembly 110, and a portion of a backplate 120.

The portion of the display array assembly 110 includes the display element D₂₂ of FIG. 5A. The display element D₂₂ includes a portion of a front substrate 20, a portion of an optical stack 16 formed on the front substrate 20, supports 18 formed on the optical stack 16, a movable electrode 14 supported by the supports 18, and an interconnect 126 electrically connecting the movable electrode 14 to one or more components of the backplate 120. The portion of the backplate 120 includes the second data line DL2, the second gate line GL, the processing unit PU₂₂ of FIG. 5A, and interconnects 128a and 128b.

FIG. 6 shows an example of a schematic block diagram of an array of image data processing units for an optical MEMS display. Referring to FIG. 6, an array of image data processing units in the backplate of a display device according to some implementations will be described below. FIG. 6 only depicts a portion of the array, which includes processing units PU₁₁, PU₂₁, PU₃₁ on a first row, processing units PU₁₂, PU₂₂, PU₃₂ on a second row, and processing units PU₁₃, PU₂₃, PU₃₃ on a third row. Other portions of the array can have a configuration similar to that shown in FIG. 6.

In the illustrated implementation, each of the processing units PU₁₁-PU₃₃ is configured to be in bi-directional data communication with neighboring processing units. The term “neighboring processing unit” generally refers to a processing unit that is nearby the processing unit of interest and is on the same row, column, or diagonal line as the processing unit of interest. A person having ordinary skill in the art will readily appreciate that a neighboring processing unit also can be at any location proximate to the processing unit of interest, but at a location different from that defined above.

In FIG. 6, the processing unit PU₁₁, which is at the upper left corner, is in data communication with the processing units PU₂₁, PU₂₂, and PU₁₂. For another example, the processing unit PU₂₁, which is on the first row between two other processing units on the first row, is in data communication with the processing units PU₁₁, PU₃₁, PU₁₂, PU₂₂, and PU₃₂. For another example, the processing unit PU₂₂, which is surrounded by other processing units, is in data communication with the processing units PU₁₁, PU₂₁, PU₃₁, PU₁₂, PU₃₂, PU₁₃, PU₂₃, and PU₃₃.

In some implementations, each of the processing units PU₁₁-PU₃₃ can be electrically coupled to each of neighboring processing units by separate conductive lines or wires, instead of a bus that can be shared by multiple processing units. In some other implementations, the processing units PU₁₁-PU₃₃ can be provided with both separate lines and a bus for data communication between them. In some other implementations, a first processing unit may communicate data to a second processing unit though at least a third processing unit.

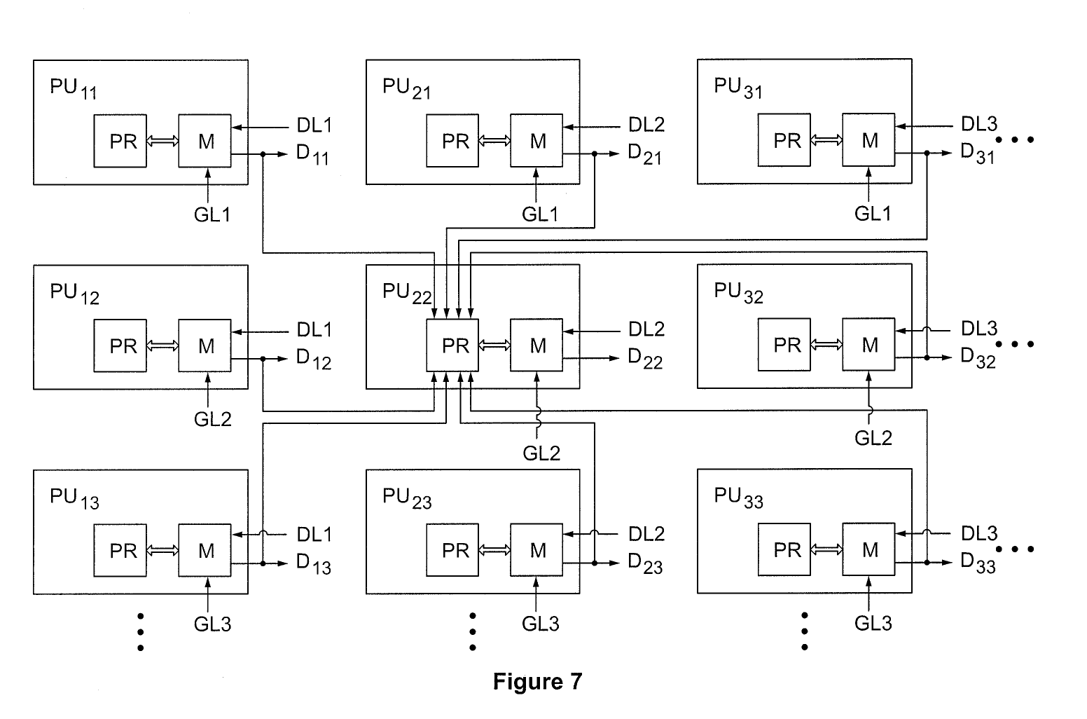

FIG. 7 shows an example of a schematic block diagram of an array of image data processing units for an optical MEMS display. The array of image data processing units in FIG. 7, as well as FIG. 5A, can be used for dithering in a display device. FIG. 7 only depicts a portion of the array, which includes processing units PU₁₁, PU₂₁, PU₃₁ on a first row, processing units PU₁₂, PU₂₂, PU₃₂ on a second row, and processing units PU₁₃, PU₂₃, PU₃₃ on a third row. Other portions of the array can have a configuration similar to that shown in FIG. 7.

In some implementations, each of the processing units PU₁₁-PU₃₃ in the array can include a processor PR and a memory M in data communication with the processor PR. The memory M in each of the processing units PU₁₁-PU₃₃ can receive raw image data from a data line DL1-DLm (as depicted in FIG. 5A), and output processed image data to an associated display element. For example, the memory M of the processing unit PU₂₂ can receive raw image data from the second data line DL2, and output processed (e.g., dithered) image data to its associated display element D₂₂.

The processor PR of each of the processing units PU₁₁-PU₃₃ also can be in data communication with the memories M of neighboring processing units. For example, the processor PR of the processing unit PU₂₂ can be in data communication with the memories of the processing units PU₁₁, PU₂₁, PU₃₁, PU₁₂, PU₃₂, PU₁₃, PU₂₃, and PU₃₃. In the illustrated implementation, the processor PR of each of the processing units PU₁₁-PU₃₃ can receive processed (e.g., dithered) image data from the memories M of the neighboring processing units.

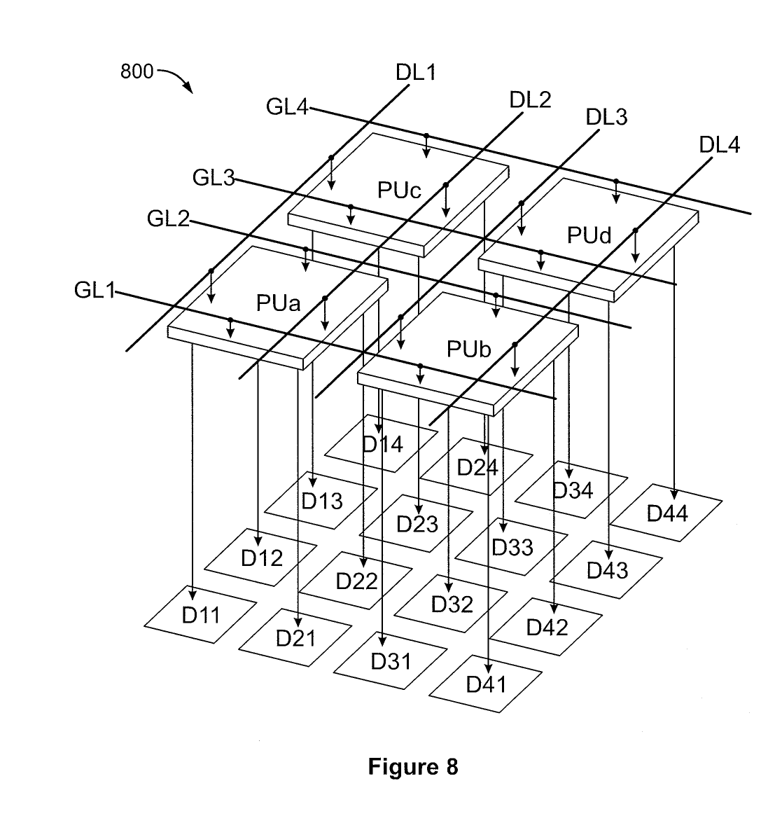

FIG. 8 shows an example of a schematic partial perspective view of an array of image data processing units for an optical MEMS display. Referring to FIG. 8, a driving circuit array 800 of a display device according to another implementation will be described below. The illustrated driving circuit array 800 can be used for implementing an active matrix addressing scheme for providing image data to display elements D₁₁-Dₘₙ of a display array assembly.

The driving circuit array 800 can include an array of processing units in the backplate of the display device. The illustrated portion of the driving circuit array 800 includes first to fourth data lines DL1-DL4, first and fourth gate lines GL1-GL4, and first to fourth processing units PUa, PUb, PUc, and PUd. A person having ordinary skill in the art will readily appreciate that other portions of the driving circuit array can have substantially the same configuration as the depicted portion.

In the illustrated implementation, the number of processing units is less than the number of display elements D11-D44. For example, a ratio of the number of the display elements to the number of the processing units can be x:1, where x is an integer greater than 1, for example, any integer from 2 to 100, such as 4, 9, 16, etc.

Each of the data lines DL1-DLm extends from a data driver (not shown). A pair of adjacent data lines are electrically connected to a respective one of processing units. In the illustrated implementation, the first and second data lines DL1, DL2 are electrically connected to the first and third processing units PUa and PUc. The third and fourth data lines DL3, DL4 are electrically connected to the second and fourth processing units PUb and PUd. The data lines DL1-DL4 serve to provide raw image data to the processing units PUa, PUb, PUc, and PUd.

Two adjacent ones of the first to n-th gate lines GL1-GL4 extend from a gate driver (not shown), and are electrically connected to a respective row of processing unit PUa, PUb, PUc, and PUd. In the illustrated portion of the driving circuit array, the first and second gate lines GL1, GL2 are electrically connected to the first and second processing unit PUa, PUb. The third and fourth gate lines GL3, GL4 are electrically connected to the third and fourth processing unit PUc, PUd.

Each of the processing units PUa, PUb, PUc, and PUd can be electrically coupled to a group of four display elements D₁₁-D₄₄ while being configured to receive switching control signals from the gate driver (not shown) via two of the gate lines GL1-GLn. In the illustrated implementation, a group of four display elements D₁₁, D₂₁, D₁₂, and D₂₂ are electrically connected to the first processing unit PUa, and another group of four display elements D₃₁, D₄₁, D₃₂, and D₄₂ are electrically connected to the second processing unit PUb. Yet another group of four display elements D₁₃, D₂₃, D₁₄, and D₂₄ are electrically connected to the third processing unit PUc, and another group of four display elements D₃₃, D₄₃, D₃₄, and D₄₄ are electrically connected to the fourth processing unit PUd.

During operation, the data driver (not shown) receives image data from outside the display, and provides the image data to the array of the processing units, including the processing units PUa, PUb, PUc, and PUd via the data lines DL1-DL4. The array of the processing units PUa, PUb, PUc, and PUd process the image data for dithering, and store the processed data in the memory thereof. The gate driver (not shown) selects a row of display elements D₁₁-Dₘ₁, D₁₂-Dₘ₂, . . . , D₁ₙ-Dₘₙ. Then, the processed image data is provided to the selected row of display elements D₁₁-Dₘ₁, D₁₂-Dₘ₂, . . . , D₁ₙDₘₙ from the corresponding row of processing units.

The processing units PUa, PUb, PUc, and PUd of FIG. 8 perform image data processing for four associated display elements, instead of a single display element. Thus, the size and capacity of each of the processing units PUa, PUb, PUc, and PUd of FIG. 8 can be greater than those of each of the processing units PU₁₁-PUₘₙ of FIG. 5A. Each of the processing units PUa, PUb, PUc, and PUd of FIG. 8 can be implemented to process more data than each of the processing units PU₁₁-PUₘₙ when the driving circuits employ the same dithering algorithm. However, the overall operations of the processing units PUa, PUb, PUc, and PUd of FIG. 8 are substantially the same as the overall operations of the processing units PU₁₁-PUₘₙ of FIG. 5A.

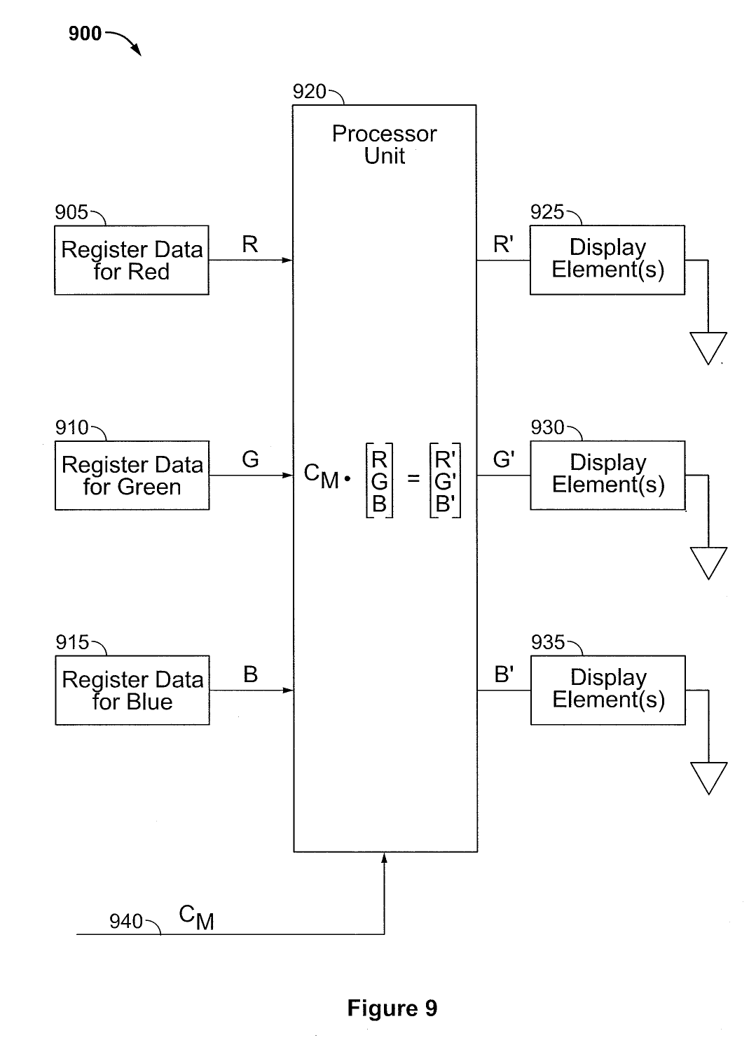

FIG. 9 shows an example of a schematic block diagram of an augmented active matrix pixel 900 with an integral processor unit configured to process color data. This Figure illustrates the use of a local processor and memory for modifying image data for display. Registers 905, 910 and 915 receive color image data for each primary color in the RGB scheme for the local pixel and provide that data to processor unit 920 for processing. The registers 905, 910 and 915 are illustrated external to the processor unit 920, but could be internal instead. Processor unit 920 is configured to process image data at the pixel, rather than off the display. Processor unit 920 also receives color processing data via data line 940. In this example, the pixel controlled by processing unit 920 includes a plurality of display elements (925, 930 and 935, respectively) having different output wavelength bands. The display elements 925, 930 and 935 may be analog IMODs, for example, which respond with different colors and brightness depending on an analog voltage applied at input lines R′, G′, and B′. Within processor unit 920, the processing data is used to modify the raw image RGB data to form processed R′G′B′ data. The processed R′G′B′ data is then sent to display elements 925, 930 and 935 for display. In this implementation, a 3×3 matrix C_{M} may be received via data line 940, stored and then used to transform multi-bit image data (e.g., 2, 6 or 8 bits per color) into, e.g., analog output levels that place the display elements 925, 930 and 935 in the appropriate states to reproduce the desired pixel color and brightness. Thus, in this implementation, processing of image data at the pixel is accomplished without the need to process data outside of the display and then write it back to the display. This reduces the load on off-display processors. If the processing performed by the processing unit is changed (for adjusting brightness and color saturation for example) this also reduces the overall power consumption because the processed image data need not be written back to the display after processing.

A variety of other uses of the processing unit and memory of FIG. 9 are possible. For example, if the processor units 920 are interconnected as illustrated, for example, in FIG. 6, then local image filtering functions and/or spatial dithering functions can be performed by processor unit 920.

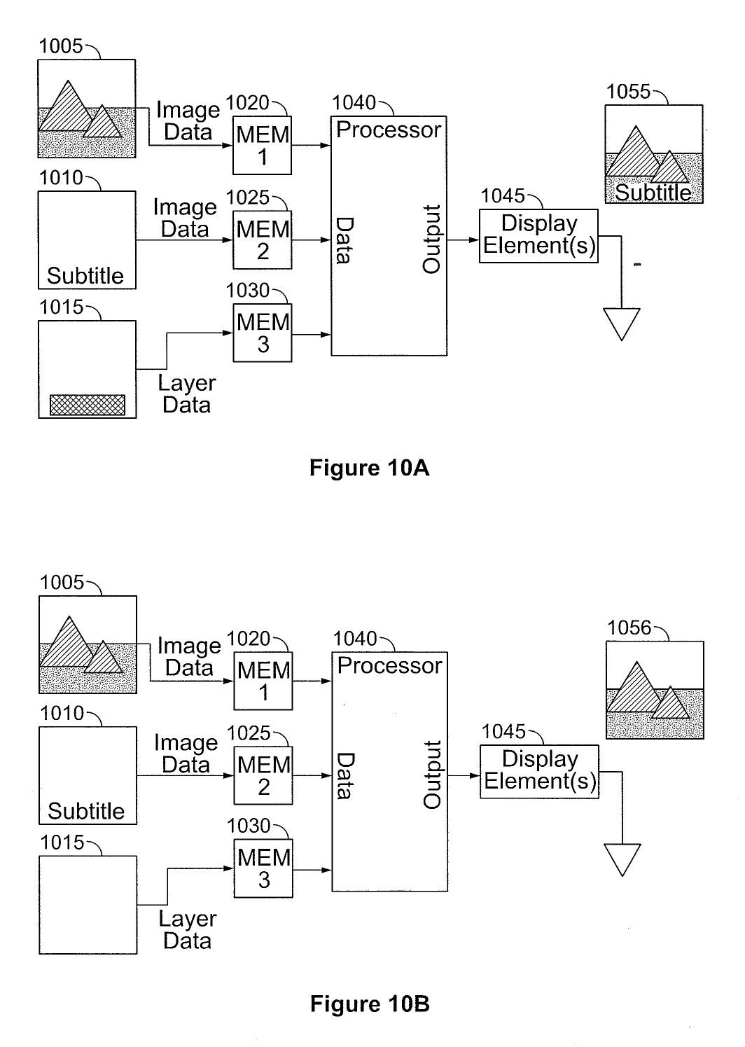

FIGS. 10A and 10B show examples of schematic block diagrams of augmented active matrix pixels with integral processor units and memory units configured to implement alpha compositing. Alpha compositing is a method of image definition and manipulation that allows images to be overlaid on one another to place objects in a foreground or background, and also can define levels of transparency for objects.

In FIGS. 10A and 10B, a processor unit 1040 is electrically connected to a plurality of memory units (1020, 1025 and 1030) to form an augmented active matrix pixel. Thus, in FIG. 10A, image data from images 1005 and 1010 is stored in memory units 1020 and 1025 for the pixel associated with processor 1040. Specifically, memory unit 1020 stores image data for the given pixel for a background image 1005 and memory unit 1025 stores image data for the given pixel for a subtitle 1010, which may be selectively displayed over background image 1005. Memory unit 1030 stores layer data, which may be referred to as the “alpha channel,” which defines how the image data stored in memory units 1020 and 1025 is to be displayed at the given pixel. Memory unit 1030 may store data indicating that the image data in memory 1020 is to be displayed, it may store data indicating that the image data in memory 1025 is to be displayed, or it may store data indicating how the image data in memory unit 1020 is to be combined with the image data in memory 1025 before display at the pixel.

When, as is shown in FIG. 10A, processor unit 1040 determines based on the alpha channel data stored in memory unit 1030 that some display elements are affected by the layering, processor unit 1040 can cause the display of the subtitle 1010 image data stored in memory unit 1025 at the appropriate display elements. This results in a display image 1055 that includes the subtitle 1010 image data. Alternatively, when, as is shown in FIG. 10B, the alpha channel data indicates that no part of the image of the subtitle 1010 is to be displayed, the processor units 1040 at each pixel display the image data stored in their respective memory units 1020. Thus, display image 1056 includes no subtitle 1010 image data. Accordingly, with this implementation, layering of image data is accomplished using an augmented active matrix pixel without the need to process data outside of the display and write it back to the display. Further, because the layered image data is stored at the pixel, the layering effect can be selectively activated and deactivated without writing any additional image data to the display. This may result in a substantial power savings of the display device.

It is also possible to combine movement of the data in one or more of the memory elements 1020, 1025, or 1030 to the memory elements of other pixels in the array, via, for example, the communication paths illustrated in FIG. 6. This could be used to implement, for example, scrolling of subtitle or other text information stored in memory location 1025 over static image data stored in memory locations 1020. Each time the processor places data at the display element(s) 1045, the data in memory location 1025 could be shifted data from pixels above, below, left or right. This allows the presentation of moving images without writing new data to the display except for pixels at the edges of the display. This technique could also be used to implement a display technique wherein foreground objects and scenery are moved at a faster rate than background objects and scenery to create a better representation of visual depth when the image is panned across a landscape for example. In this implementation, data from multiple memories could be transferred to the corresponding memories of other pixels of the display, but at different scrolling rates.

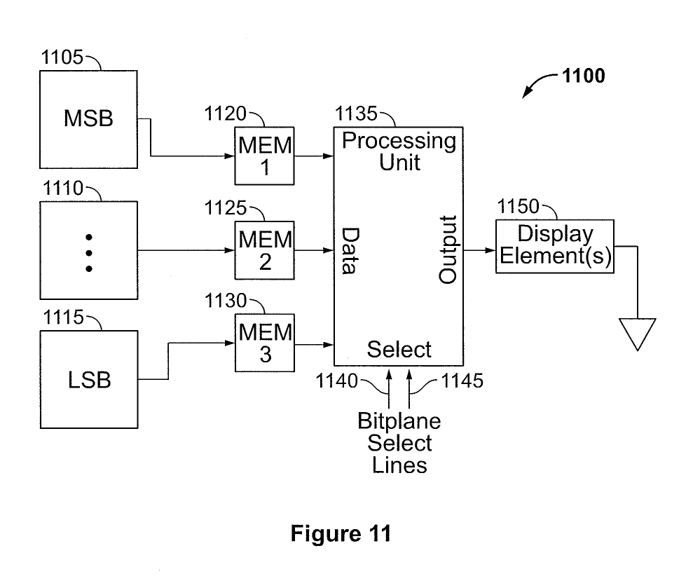

FIG. 11 shows an example of a schematic block diagram of an augmented active matrix pixel with integral processor unit and memory units configured to implement temporal modulation. Temporal modulation is a method of increasing the perceived resolution of a display device by displaying different images for different amounts of time. Because of the way the human brain interprets the images, the resulting image may appear to be higher resolution than the display can actually produce. To implement temporal modulation, multiple versions of a single image may be stored representing different temporal aspects of the image. Each version of the image is then displayed for a period of time to create the impression of an overall higher resolution image to a viewer. Thus, multiple temporal versions of a single image may be displayed repeatedly to create the impression of a single higher resolution image. Accordingly, as is shown in FIG. 11, multiple memory units (1120, 1125 and 1130) are electrically connected to processor unit 1135. In this implementation, each of the memory units (1120, 1125 and 1130) is configured to store a “bit-plane,” i.e., a particular temporal version of an image for display. Processor unit 1135 is electrically connected to multiple bitplane selection lines, i.e., 1140 and 1145, which, when activated, select which bit-plane the processor unit 1135 should display during a certain period of time. By storing the bit-plane image data at the pixel in memory units 1120, 1125 and 1130, and processing the selection and display of that bit-plane at the pixel, the need to rewrite multiple bit-planes of image data to the display over and over again to create temporal modulation is reduced. The reduction in data written to the display from outside the display reduces the power consumption of the display device.

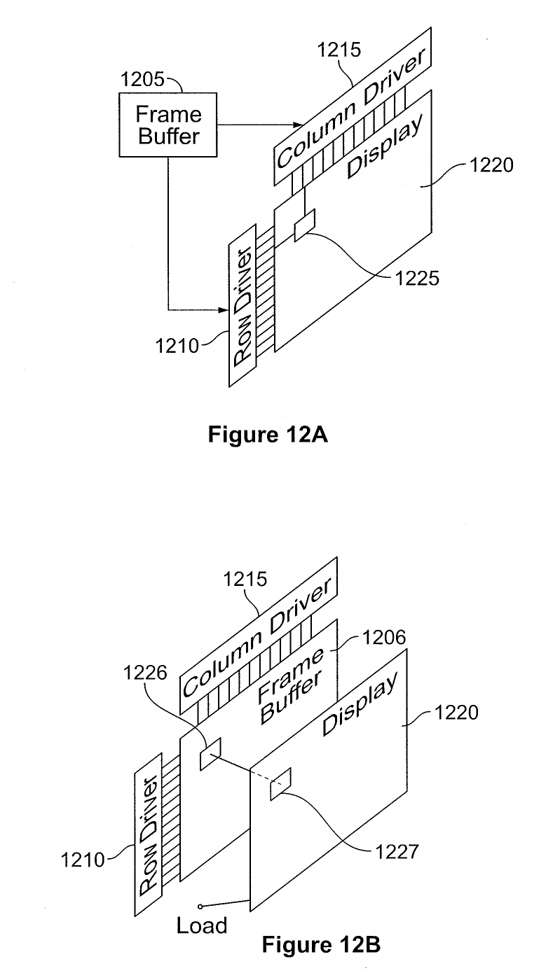

FIGS. 12A and 12B show examples of displays configured to buffer image data. Multiple buffering is a technique used to reduce flicker, tearing, and other undesirable artifacts on display devices during screen refreshes. By augmenting active matrix pixels with integral memory units and processor units, more advanced buffering techniques such as multiple-buffering are possible. In these implementations, the functions of an independent frame buffer and the local memory units at the pixel are able to be combined to increase buffering performance. FIG. 12A shows a typical implementation of a prior art display with an external frame buffer. In FIG. 12A, a display driver writes image data to frame buffer 1205 row-by-row. The column driver 1215 and row driver 1210 then write that image data to pixels in the display (e.g., pixel 1225) row-by-row. During display updates, artifacts such as “tearing” may appear when the frame buffer is not completely filled before the image needs to be updated or when the frame buffer contains previous frame data while a new frame is being written to the display 1220. FIG. 12B shows an example of double-buffering using memory units at the pixel. In this implementation, an array of memory units (e.g., memory unit 1226) at the pixels forms a frame buffer. In FIG. 12B, while the frame buffer 1206 is being loaded with image data sequentially (e.g., row-by-row), the image data is transferred to display elements (e.g., display element 1227) for display simultaneously. Alternatively, frame buffer 1206 may be filled completely with image data in a row-by-row sequential manner, and then this image data may all be transferred to the pixels for display simultaneously. This can eliminate visual artifacts caused by row-by-row image display updating. In yet another implementation, the frame buffer 1206 formed by the active matrix pixel memory units may be formed as two separate frame buffers to accomplish a form of multiple buffering called page-flip buffering. In page flip buffering, one buffer is actively being written to the display while the other buffer is being updated with new image data for a new image frame. When writing to the buffer being updated is complete, the roles of the two buffers are switched. In this way, there is always an image buffer filled with image data ready to be displayed, and there is no lag caused by writing new image data to either of the frame buffers. Page-flip buffering is faster than copying the data between buffers and significantly reduces tearing artifacts during display of active images.

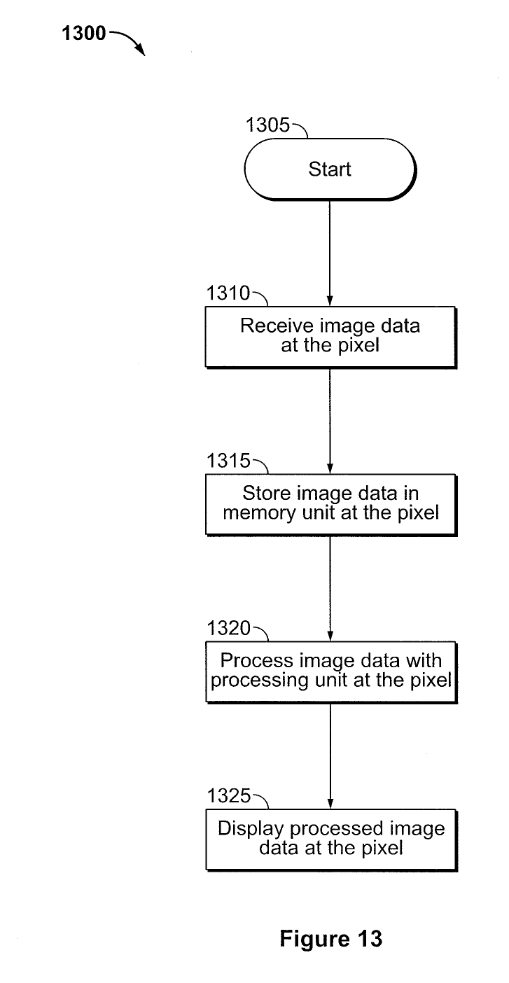

FIG. 13 shows an example of a method of storing and processing image data with an augmented active matrix pixel. The method starts at block 1305. Next an active matrix pixel receives image data at block 1310. At block 1315, the active matrix pixel stores the image data in a memory unit located at the pixel. At block 1320, the active matrix pixel's processor unit processes the image data. Finally, at block 1325, the active matrix pixel displays the processed image data using display elements.

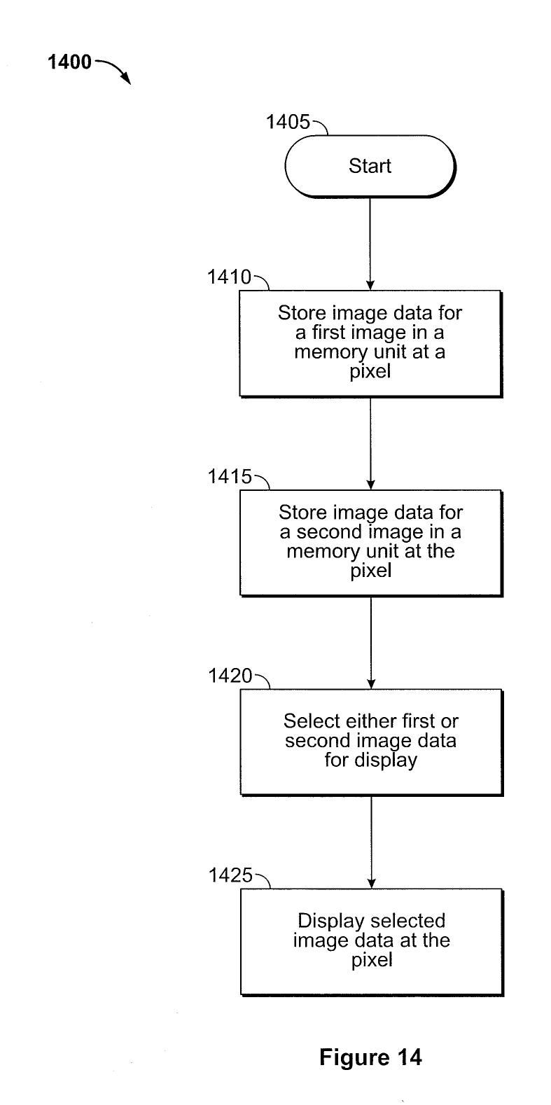

FIG. 14 shows an example of a method of temporally modulating image data with an augmented active matrix pixel. As described above with reference to FIG. 11, temporal modulation involves storing and displaying several temporal versions of a single image over and over again to create the illusion of a higher resolution image. In prior art methods, these multiple versions of the image, or bitplanes, would be written to the display over and over again. However, by using augmented active matrix pixels, multiple bitplanes may be stored locally at the pixel and selected for display without writing new image data to the display. Accordingly, a method of temporally modulating image data using active matrix pixels starts at block 1405. Next, image data for a first image is stored in an active matrix pixel's memory unit at block 1410. At block 1415, image data for a second image is stored in an active matrix pixel's memory unit. At block 1420, image data for the first or the second image is selected for display. Finally, at block 1425, the selected image data is displayed by the active matrix pixel.

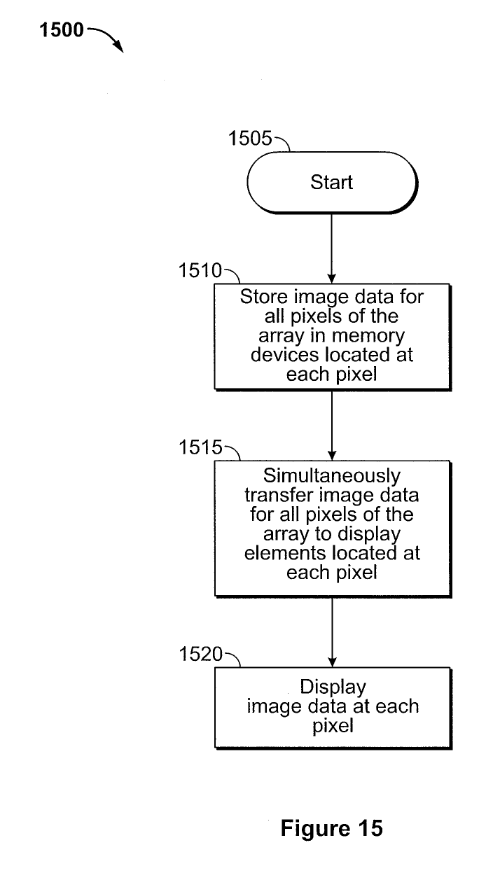

FIG. 15 shows an example of a method of implementing advanced buffering techniques with an augmented active matrix pixel. As described above with reference to FIG. 12A, traditional buffering techniques write image data line-by-line to a frame buffer that is external to the display and then the image data is then written to the display line-by-line. However, because of the line-by-line nature of the image data writes, it is possible to get image artifacts as the display is rapidly refreshed. By implementing active matrix pixels with memory units, the pixels themselves can become the frame buffer and the display can be written all at once instead of line-by-line by simultaneously transferring all of the locally stored image data (at the pixels) to the display elements at the pixels. Accordingly, a method to implement advanced buffering of augmented active matrix pixels starts at block 1505. At block 1510, image data for all the pixels of the array is stored in memory devices located at each pixel. Next, at block 1515, all of the image data for all pixels of the array is simultaneously transferred to display elements located at each pixel. Finally, at block 1520, each pixel in the array displays the image data. Because all of the image data is transferred simultaneously to the display, image artifacts are reduced when refreshing the display.

A person/one of ordinary skill in the art will appreciate that the processing circuitry associated with the pixels need not be limited to performing only one of the functions described above, and that one or more of the above described content manipulation techniques could be simultaneously or serially implemented on the same or different frames being displayed on a single display device.

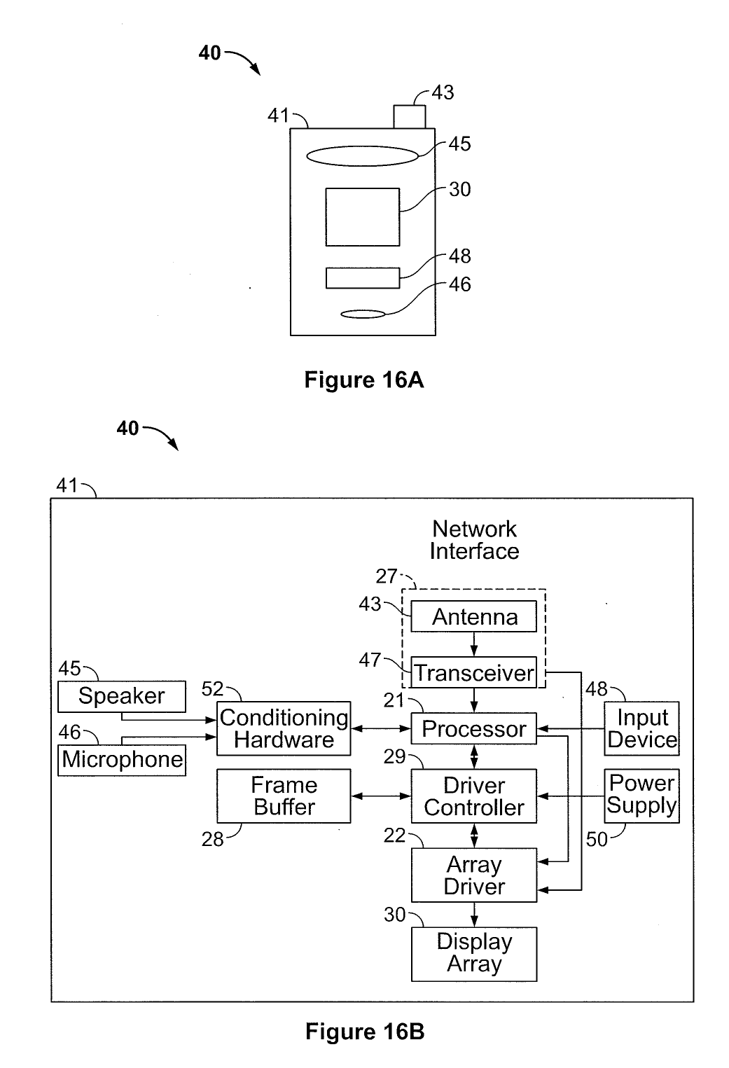

FIGS. 16A and 16B show examples of system block diagrams illustrating a display device that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 16B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11-a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and fitters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

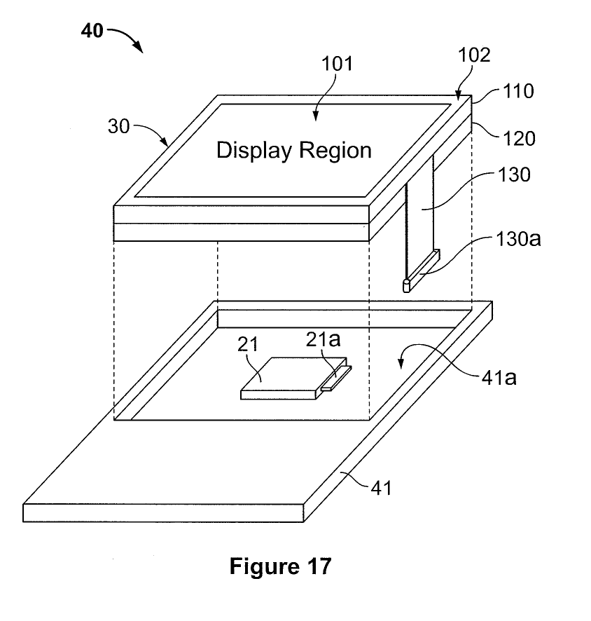

FIG. 17 shows an example of a schematic exploded perspective view of an electronic device having an optical MEMS display. The illustrated electronic device 40 includes a housing 41 that has a recess 41a for a display array 30. The electronic device 40 also includes a processor 21 on the bottom of the recess 41a of the housing 41. The processor 21 can include a connector 21a for data communication with the display array 30. The electronic device 40 also can include other Components, at least a portion of which is inside the housing 41. The other components can include, but are not limited to, a networking interface, a driver controller, an input device, a power supply, conditioning hardware, a frame buffer, a speaker, and a microphone, as described earlier in connection with FIG. 16B.

The display array 30 can include a display array assembly 110, a backplate 120, and a flexible electrical cable 130. The display array assembly 110 and the backplate 120 can be attached to each other, using, for example, a sealant.

The display array assembly 110 can include a display region 101 and a peripheral region 102. The peripheral region 102 surrounds the display region 101 when viewed from above the display array assembly 110. The display array assembly 110 also includes an array of display elements positioned and oriented to display images through the display region 101. The display elements can be arranged in a matrix form. In some implementations, each of the display elements can be an interferometric modulator. Also, in some implementations, the term “display element” may be referred to as a “pixel.”

The backplate 120 may cover substantially the entire back surface of the display array assembly 110. The backplate 120 can be formed from, for example, glass, a polymeric material, a metallic material, a ceramic material, a semiconductor material, or a combination of two or more of the foregoing materials, in addition to other similar materials. The backplate 120 can include one or more layers of the same or different materials. The backplate 120 also can include various components at least partially embedded therein or mounted thereon. Examples of such components include, but are not limited to, a driver controller, array drivers (for example, a data driver and a scan driver), routing lines (for example, data lines and gate lines), switching circuits, processors (for example, an image data processing processor) and interconnects.

The flexible electrical cable 130 serves to provide data communication channels between the display array 30 and other components (for example, the processor 21) of the electronic device 40. The flexible electrical cable 130 can extend from one or more components of the display array assembly 110, or from the backplate 120. The flexible electrical cable 130 can include a plurality of conductive wires extending parallel to one another, and a connector 130a that can be connected to the connector 21a of the processor 21 or any other component of the electronic device 40.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
at least one substrate;
an array of display elements associated with the at least one substrate and configured to display an image;
an array of processor units associated with the at least one substrate, wherein each processor unit is configured to process image data for a respective portion of the display elements; and
an array of memory units associated with the array of processor units, wherein each memory unit is configured to store data for a respective portion of the display elements.

2. The display device of claim 1, wherein each of the display elements includes an interferometric modulator.

3. The display device of claim 1, wherein each of the processing units is configured to process image data provided to its respective portion of the display elements for processing a color to be displayed by the portion of the display elements.

4. The display device of claim 1, wherein each of the processing units is configured to process image data provided to its respective portion of the display elements for layering an image to be displayed by the array of display elements.

5. The display device of claim 1, wherein each of the processing units is configured to process image data provided to its respective portions of the display elements for temporally modulating an image to be displayed by the array of display elements.

6. The display device of claim 1, wherein each of the processing units is configured to process image data provided to its respective portion of the display elements for double-buffering an image to be displayed by the array of display elements.

7. The display device of claim 1, further comprising:
a display;
a processor that is configured to communicate with the display, the processor being configured to process image data; and
a memory device that is configured to communicate with the processor.

8. The display device of claim 7, further comprising a driver circuit configured to send at least one signal to the display.

9. The display device of claim 8, further comprising a controller configured to send at least a portion of the image data to the driver circuit.

10. The display device of claim 7, further comprising an image source module configured to send the image data to the processor.

11. The display device of claim 10, wherein the image source module includes at least one of a receiver, transceiver, and transmitter.

12. The display device of claim 7, further comprising an input device configured to receive input data and to communicate the input data to the processor.

13. A display device comprising:
means for receiving image data at a pixel;
means for storing the image data at the pixel; and
means for processing the image data at the pixel.

14. The display device of claim 13, further comprising one or more display elements located at the pixel.

15. The display device of claim 14, wherein the one or more display elements are interferometric modulators.

16. A method of processing an image for a display device including an array of pixels, the method comprising:
receiving image data at a pixel;
storing the image data in a memory unit located at the pixel; and
processing the image data with a processing unit located at the pixel.

17. The method of claim 16, further comprising:
receiving color processing data at the pixel;
processing the stored image data according to the color processing data; and
displaying the processed image data at the pixel.

18. The method of claim 16, further comprising:
receiving layer image data at the pixel;
storing layer image data in a memory unit located at the pixel;
receiving layer selection data at the pixel; and
displaying at least one of the image data or the layer image data at the pixel according to the layer selection data.

19. The method of claim 16, further comprising:
receiving image data having a color depth at the pixel; and
temporally modulating the display elements of the pixel to reproduce the color depth at the pixel.

20. The method of claim 16, further comprising:
receiving image data at all the pixels of the display; and
simultaneously writing the image data to substantially all the pixels of the display.

21. A method of displaying image data at a display device including an array of pixels, comprising:
storing data for a plurality of images in a memory device located at a pixel;
selecting image data from one of the plurality of images; and
displaying the selected image data at the pixel.

22. The method of claim 21 further comprising storing alpha channel data in a memory device located at the pixel.

23. The method of claim 22, wherein the selection of image data is based at least in part on the alpha channel data.

24. A method of displaying image data at a display device including an array of pixels, comprising:
storing first image data for all the pixels of the array in memory devices located at each pixel; and
simultaneously transferring the first image data for all the pixels of the array to display elements located at each pixel for display.

25. The method of claim 24, further comprising storing second image data for all the pixels in the array in memory devices located at each pixel while the first image data is being displayed.

26. The method of claim 25 further comprising:
simultaneously transferring the second image data for all the pixels of the array to display elements located at each pixel for display; and
storing third image data for all the pixels in the array in memory devices located at each pixel while the second image data is being displayed.
